(19) United States
(12) Patent Application Publication
(10) Pub. No.: US 2006/0017665 A1
(43) Pub. Date: Jan. 26, 2006

(54) Organic light emitting display device

(76) Inventors: Chun-Seok Ko, Hwaseong-si (KR); Nam-Deog Kim, Yongin-si (KR); Byung-Sik Koh, Gwangmyeong-si (KR); In-Su Joo, Seongnam-si (KR)

Correspondence Address: CANTOR COLBURN, LLP, 55 GRIFFIN ROAD SOUTH, BLOOMFIELD, CT, 06002, US

(21) Appl. No.: 11/183,068

(22) Filed: Jul. 15, 2005

(30) Foreign Application Priority Data
Jul. 22, 2004 (KR) 2004-57069
May 16, 2005 (KR) 2005-40723

(51) Int. Cl. G09G 3/30

(52) U.S. Cl. 345/76

(57) ABSTRACT

An OLED includes a display panel, a printed circuit board, a signal transmission member and a voltage transmission member. The display panel has a display region and peripheral regions. The display panel displays an image by an organic light emitting element within the display region. The printed circuit board applies a driving signal and a voltage to the display panel. The signal transmission member electrically connects the printed circuit board to the display panel to transmit the driving signal and the voltage to the display panel. The voltage transmission member transmits the voltage to the display panel. Therefore, an amount of the current applied to the display panel is increased.

This application claims priority to Korean Patent Application No. 2004-57069, filed on Jul. 22, 2004, and Korean Patent Application No. 2005-40723, filed on May 16, 2005, and all the benefits accruing therefrom under 35 U.S.C. §119, and the contents of which in their entirety are herein incorporated by reference.

### BACKGROUND OF THE INVENTION

1. Field of the Invention

The present invention relates to an organic light emitting display device. More particularly, the present invention relates to an organic light emitting display device having an enhanced driving current.

2. Description of the Related Art

In general, an organic light emitting display device (“OLED”) generates a light using a fluorescent organic compound in response to a driving current that is from an exterior of the OLED, and displays an image by driving N×M numbers of organic light emitting cells. The organic light emitting cell includes an organic light emitting diode and a switching device. The organic light emitting diode has an anode electrode layer, an organic light emitting thin layer, and a cathode electrode layer. The switching device applies the driving current to the organic light emitting diode.

The OLED includes a display panel having the organic light emitting cell, a gate driving part applying a gate signal and a common voltage Vcom to the display panel and a data driving part applying a data signal and a source voltage Vdd to the display panel.

The gate driving part includes a gate driving chip and a gate printed circuit board (“PCB”). The data driving part has a data driving chip and a data PCB. The gate PCB is electrically connected to the display panel through a gate tape carrier package (“TCP”). The data PCB is electrically connected to the display panel through a data TCP.

Further, the common voltage Vcom is applied to the display panel through a voltage supplying line that is formed on the gate TCP. The source voltage Vdd is applied to the display panel through a voltage supplying line that is formed on the data TCP.

When a size of the display panel increases, the OLED needs greater voltage levels of the common voltage Vcom and the source voltage Vdd.

Therefore, an amount of current formed by the common voltage Vcom and the source voltage Vdd applied to the display panel through the voltage supplying lines that are formed on the gate TCP and the data TCP is limited, and the common voltage Vcom and the source voltage Vdd having insufficient voltage levels are applied to the display panel.

### BRIEF SUMMARY OF THE INVENTION

The present invention provides an organic light emitting display device (“OLED”) so as to apply a driving current more effectively to an organic light emitting element.

In one exemplary embodiment, an OLED includes a display panel, a first printed circuit board, a plurality of first signal transmission members, and a first voltage transmission member. The display panel has a display region and a plurality of peripheral regions. The display panel displays an image by an organic light emitting element within the display region. The first printed circuit board is adjacent one of the peripheral regions. The first printed circuit board applies a first driving signal and a voltage to the display panel. The first signal transmission members electrically connect the first printed circuit board to the display panel to transmit the first driving signal and the voltage to the display panel. The first voltage transmission member transmits the voltage to the display panel.

In another exemplary embodiment, an OLED includes a display panel, a first printed circuit board, and a first voltage transmission member. The display panel has a display region, a first peripheral region, a second peripheral region, a third peripheral region, and a fourth peripheral region. The first to fourth peripheral regions are adjacent the display region. The display panel displays an image by an organic light emitting element within the display region. The first printed circuit board is adjacent one of the first, second, third, and fourth peripheral regions. The first printed circuit board applies a first driving signal to the display panel. The first voltage transmission member is on another of the first, second, third, and fourth peripheral regions. The first voltage transmission member applies a voltage to the display panel.

In still another exemplary embodiment, an OLED includes a display panel, a first printed circuit board, and a first voltage transmission member. The display panel has a display region, a first peripheral region, a second peripheral region, a third peripheral region, and a fourth peripheral region. The first to fourth peripheral regions are adjacent the display region. The display panel displays an image by an organic light emitting element. The first printed circuit board is adjacent the first peripheral region. The first printed circuit board applies a first driving signal and a first voltage to the display panel. The second printed circuit board is adjacent the second peripheral region. The second printed circuit board applies a second driving signal and a second voltage to the display panel. The first signal transmission members are spaced apart from one another by a first distance. The first signal transmission members electrically connect the first printed circuit board to the display panel. The second signal transmission members are spaced apart from one another by a second distance. The second signal transmission members electrically connect the second printed circuit board to the display panel. The first voltage transmission member is disposed between the first signal transmission members. The first voltage transmission member applies the first voltage to the display panel. The second voltage transmission member is disposed between the second signal transmission members. The second voltage transmission member applies the second voltage to the display panel.

In yet another exemplary embodiment, an organic light emitting display device includes a display panel, a signal transmission member transmitting a driving signal to the display panel, and a voltage transmission member separate from the signal transmission member and transmitting only a voltage to the display panel.

Therefore, the OLED includes the voltage transmission member between the signal transmission members or between the third and fourth peripheral regions so that an amount of current formed by the voltage applied to the display panel is increased. In addition, a level of the voltage applied to the display panel is increased. Furthermore, a reliability of the display panel is improved.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is a plan view of an exemplary embodiment of an organic light emitting display device (“OLED”);

FIG. 2 is a cross-sectional view of the OLED shown in FIG. 1;

FIG. 3 is a cross-sectional view taken along line I-I′ of FIG. 1;

FIG. 4 is a plan view showing an exemplary second peripheral region of the display panel of FIG. 1;

FIG. 5 is a cross-sectional view taken along line II-II′ of FIG. 4;

FIG. 6 is a plan view showing another exemplary embodiment of an OLED;

FIG. 7 is a plan view showing an exemplary third peripheral region and an exemplary fourth peripheral region of the display panel of FIG. 6; and

FIG. 8 is a plan view showing another exemplary embodiment of an OLED.

### DETAILED DESCRIPTION OF THE INVENTION

Hereinafter, the preferred embodiments of the present invention will be described in detail with reference to the accompanied drawings. In the drawings, the thickness of layers, films, and regions are exaggerated for clarity. Like numerals refer to like elements throughout. It will be understood that when an element such as a layer, film, region, or substrate is referred to as being “on” another element, it can be directly on the other element or intervening elements may also be present.

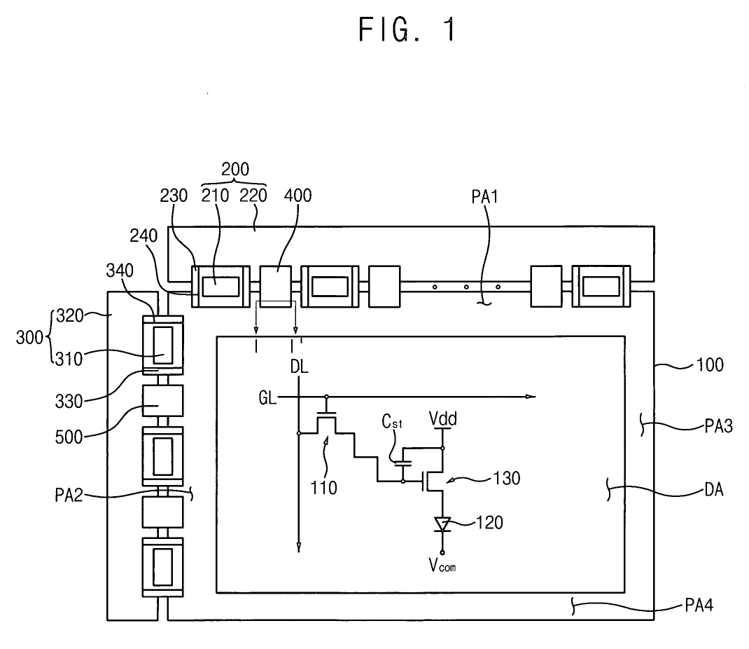

FIG. 1 is a plan view of an exemplary embodiment of an organic light emitting display device (“OLED”).

Referring to FIG. 1, an OLED includes a display panel 100 displaying an image, a data driving part 200 applying a data signal and a source voltage Vdd to the display panel 100 for displaying the image, a gate driving part 300 applying a gate signal and a common voltage Vcom to the display panel 100 for displaying the image, a first flexible printed circuit board 400 applying the source voltage Vdd to the data driving part 200, and a second flexible printed circuit board 500 applying the common voltage Vcom to the gate driving part 300. It should be understood that there may be a plurality of flexible printed circuit boards 400 and 500 associated with the data driving part 200 and the gate driving part 300, respectively.

The display panel 100 includes a display region DA, a first peripheral region PA1 adjacent to a first side of the display region DA, a second peripheral region PA2 adjacent to a second side of the display region DA and adjacent to a side of the first peripheral region PA1, a third peripheral region PA3 adjacent to a third side of the display region DA and adjacent to another side of the first peripheral region PA1, and a fourth peripheral region PA4 adjacent to a fourth side of the display region DA.

The first and fourth sides of the display region DA may be parallel to each other, and the second and third sides of the display region DA may be parallel to each other. The fourth peripheral region PA4 is between the second and third peripheral regions PA2 and PA3. The third peripheral region PA3 is substantially parallel to the second peripheral region PA2. Likewise, the fourth peripheral region PA4 is substantially parallel to the first peripheral region PA1.

A plurality of data lines DL and a plurality of gate lines GL are formed in the display region DA, where only one exemplary data line DL and gate line GL are illustrated for clarity. The data lines DL are extended in a first direction, and the gate lines GL are extended in a second direction that is substantially perpendicular to the first direction. The data lines DL may be parallel to the first and fourth sides of the display region DA, and the gate lines GL may be parallel to the second and third sides of the display region DA. A pixel region is defined in a matrix shape on a region defined by the data lines DL and the gate lines GL adjacent to each other. While only one pixel region is described herein, it should be understood that the display region DA includes a plurality of pixel regions.

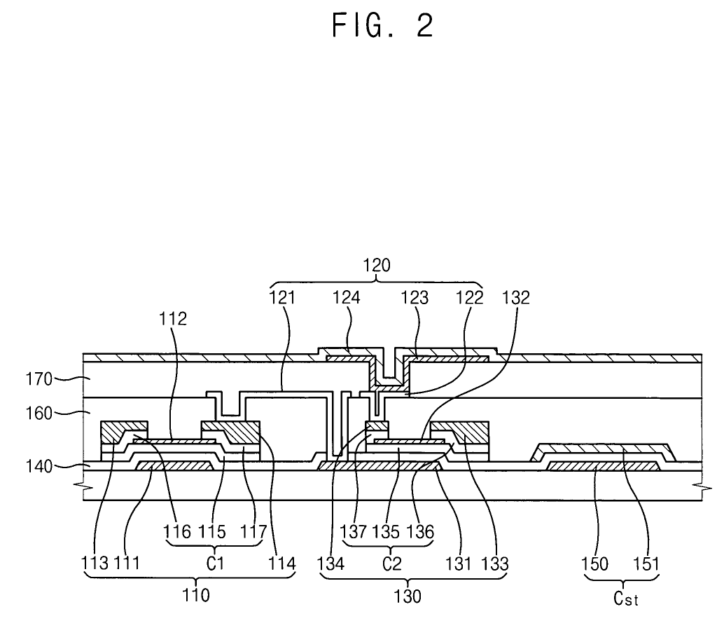

An organic light emitting element is in each pixel region. The organic light emitting element includes a first thin film transistor (“TFT”) 110 that is turned on or off in response to the gate signal from the gate line GL, a storage capacitor Cst disposed between the first TFT 110 and a source voltage line, an organic light emitting (“organic EL”) diode 120 that emits a light in response to a driving current, and a second TFT 130 disposed between the source voltage line and the storage capacitor Cst so as to control the driving current applied to the organic EL diode 120. In an exemplary embodiment, the organic EL diode 120 receives the common voltage Vcom through a cathode electrode 124 (FIG. 2) thereof.

When the first TFT 110 is turned on, the second TFT 130 is turned on in response to the data signal from the data line DL, so that the second TFT 130 provides the organic EL diode 120 with the driving current. Also, the organic EL diode 120 emits a light corresponding to the driving current applied to the organic EL diode 120 through the second TFT 130.

That is, when a forward current is applied to the organic EL diode 120, a luminescent layer 123, disposed between an anode electrode 122 and a cathode electrode 124, all as shown in FIG. 2, receives positive charge from the anode electrode 122 and electrons from the cathode electrode 124, and the positive charge is combined with the electrons. When the positive charge is combined with the electrons, the organic EL diode 120 emits the light. The first and second TFTs 110 and 130 function as a switching device and a current control device, respectively. The first TFT 110 and the second TFT 130 may be an N-type metal oxide semiconductor (“MOS”) transistor or a P-type MOS transistor, where an N-type includes a higher concentration of electrons than a concentration of holes, and a P-type includes a higher concentration of holes than a concentration of electrons.

FIG. 2 is a cross-sectional view of the OLED shown in FIG. 1.

Referring to FIG. 2, the first TFT 110 includes a first gate electrode 111, a first semiconductor pattern C1, a first etch stop pattern 112, a first source electrode 113, and a first drain electrode 114.

The first semiconductor pattern C1, which is part of the first TFT 110, is on the first gate electrode 111 and electrically insulated from the first gate electrode 111 by an insulating layer 140 having insulating materials. As will be further described below, the insulating layer 140 overlies the first gate electrode 111 of the first TFT 110, a second gate electrode 131 of the second TFT 130, and a first electrode 150 of the storage capacitor Cst. Also, the first semiconductor pattern C1 includes a first amorphous silicon pattern 115, a first n⁺ amorphous silicon pattern 116, and a second n⁺ amorphous silicon pattern 117.

In an exemplary embodiment, the first amorphous silicon pattern 115 is formed by patterning an amorphous silicon layer. Also, the first n⁺ amorphous silicon pattern 116 and the second n⁺ amorphous silicon pattern 117 are formed by patterning an amorphous silicon layer doped with dopants. Alternatively, the amorphous silicon layer may be doped and patterned to form the first amorphous silicon pattern 115, the first n⁺ amorphous silicon pattern 116, and the second n⁺ amorphous silicon pattern 117.

The first etch stop pattern 112 is formed on the first amorphous silicon pattern 115, and opposite ends of the first etch stop pattern 112 are partially covered by the first n⁺ amorphous silicon pattern 116 and the second n⁺ amorphous silicon pattern 117. Thus, ends of the first etch stop pattern 112 are interposed between the first and second n⁺ amorphous silicon patterns 116 and 117 and the first amorphous silicon pattern 115. The first n⁺ amorphous silicon pattern 116 and the second n⁺ amorphous silicon pattern 117 are formed on the first amorphous silicon pattern 115, except for the portions overlying end portions of the first etch stop pattern 112. The first etch stop pattern 112 protects the first amorphous silicon pattern 115 from an etchant by which the first n⁺ amorphous silicon pattern 116 and the second n⁺ amorphous silicon pattern 117 are patterned.

The second TFT 130 includes a second gate electrode 131, a second semiconductor pattern C2, a second etch stop pattern 132, a second source electrode 133, and a second drain electrode 134. The second gate electrode 131 is electrically connected to the first drain electrode 114 of the first TFT 110 via the connecting electrode 121, as will be further described below.

The second semiconductor pattern C2 of the second TFT 130 is on the second gate electrode 131, and electrically insulated from the second gate electrode 131 by the insulating layer 140. Also, the second semiconductor pattern C2 includes a second amorphous silicon pattern 135, a third n⁺ amorphous silicon pattern 136, and a fourth n⁺ amorphous silicon pattern 137.

In an exemplary embodiment, the second amorphous silicon pattern 135 is formed by patterning an amorphous silicon layer, which may be the same amorphous silicon layer used for patterning the first amorphous silicon pattern 115. The third n⁺ amorphous silicon pattern 136 and the fourth n⁺ amorphous silicon pattern 137 are formed by patterning an amorphous silicon layer doped with conductive dopants, that may be the same layer used for forming the first and second n⁺ amorphous silicon patterns 116, 117. The second semiconductor pattern C2 is formed from a same layer as the first semiconductor pattern C1. The second etch stop pattern 132 is formed on the second amorphous silicon pattern 135, and opposite ends of the second etch stop pattern 132 are covered by the third n⁺ amorphous silicon pattern 136 and the fourth n⁺ amorphous silicon pattern 137. That is, end portions of the second etch stop pattern 132 are interposed between the third and fourth n⁺ amorphous silicon pattern 136, 137 and the second amorphous silicon pattern 135. The third n⁺ amorphous silicon pattern 136 and the fourth n⁺ amorphous silicon pattern 137 are formed on the second amorphous silicon pattern 135. Also, the second etch stop pattern 132 protects the second amorphous silicon pattern 135 from the etchant by which the third n⁺ amorphous silicon pattern 136 and the fourth n⁺ amorphous silicon pattern 137 are patterned.

The storage capacitor Cst includes a first electrode 150 that is electrically connected to the second gate electrode 131, and a second electrode 151 that is electrically connected to the source voltage line. The insulating layer 140 is between the first electrode 150 and the second electrode 151.

Further, the organic EL diode 120 includes a connecting electrode 121, an anode electrode 122, an organic luminescent layer 123, and a cathode electrode 124. The display panel 100 further includes a first insulating interlayer 160 and a second insulating interlayer 170. The first insulating interlayer 160 overlies exposed surfaces of the first TFT 110, second TFT 130, and the storage capacitor Cst. The second insulating interlayer 170 overlies exposed portions of the connecting electrode 121, the anode electrode 122, and the first insulating interlayer 160.

The connecting electrode 121 connects the first drain electrode 114 of the first TFT 110 to the second gate electrode 131 of the second TFT 130, accomplished via a connecting hole formed in the first insulating interlayer 160 for the first drain electrode 114, and a connecting hole formed in the first insulating interlayer 160 and the insulating layer 140 for the second gate electrode 131. The connecting electrode 121 includes a material substantially identical to that of the anode electrode 122.

The anode electrode 122 is electrically connected to the second drain electrode 134 of the second TFT 130 to receive the driving current from the source voltage line. The anode electrode 122 electrically connects to the second drain electrode 134 via a connecting hole formed through the first insulating interlayer 160 to the second drain electrode 134. The anode electrode 122 also includes an optically transparent and electrically conductive material such as, but not limited to, Indium Tin Oxide (“ITO”), Indium Zinc Oxide (“IZO”), etc.

The organic luminescent layer 123 includes a red organic luminescent material, a green organic luminescent material, or a blue organic luminescent material. The organic luminescent layer 123 is disposed between the anode electrode 122 and the cathode electrode 124. The organic luminescent layer 123 connects to the anode electrode 122 via a connecting hole formed in the second insulating interlayer 170.

The cathode electrode 124 overlies the second insulating interlayer 170 and the organic luminescent layer 123. The cathode electrode 124 faces the anode electrode 122 and includes aluminum Al or an aluminum alloy having low resistance.

Although not illustrated for clarity, a negative charge injection layer, a negative charge transporting layer, a positive charge transporting layer, and a positive charge carrier injection layer are disposed between the cathode electrode 124 and the anode electrode 122. Alternatively, a color filter (not shown) may be formed over the cathode electrode 124.

Referring again to FIG. 1, the data driving part 200 includes a plurality of data driving chips 210 and a data printed circuit board 220. The data printed circuit board 220 is electrically connected to the display panel 100 through a plurality of data tape carrier packages (“TCPs”) 230. Each data driving chip 210 may be formed on a data TCP 230.

The data TCPs 230 are spaced apart from each other along the first peripheral region PA1 of the display panel 100. A first end portion of each data TCP 230 is attached to the first peripheral region PA1. A second end portion of each data TCP 230 is attached to the data printed circuit board 220. The first end portions and second end portions of the data TCPs 230 are attached to the display panel 100 and the data printed circuit board 220, respectively, through anisotropic conductive films (“ACFs”). In an exemplary embodiment, the data driving chips 210 are disposed on the data TCPs 230, respectively. Each of the data TCPs 230 includes a source voltage supplying line 240 to apply the source voltage Vdd from the data printed circuit board 220 to the display panel 100. The source voltage supplying line 240 may be positioned on a surface of the data TCP 230 that faces the ACF, for electrically connecting the source voltage supplying line 240 to the display panel 100 through the ACF.

The first flexible printed circuit board 400 is disposed between adjacent data TCPs 230. That is, a first portion of the first flexible printed circuit board 400 is attached to the first peripheral region PA1 disposed between adjacent data TCPs 230, and a second portion of the first flexible printed circuit board 400 is attached to the data printed circuit board 220. The first end and second end portions of the first flexible printed circuit board 400 are attached to the display panel 100 and the data printed circuit board 220, respectively, through ACFs. While an alternating pattern of data TCP 230, first flexible printed circuit board 400, data TCP 230, first flexible printed circuit board 400, and so on, is demonstrated, it should be understood that alternate patterns for placing the first flexible printed circuit boards 400 in relation to the data TCPs 230 are also within the scope of these embodiments.

An ACF includes a resin for adhesion between two elements and a plurality of conducting balls distributed in the resin. The conducting balls are electrically connected to each other when the resin is set, thus providing an electrical connection between the two elements that are adhered together.

In an exemplary embodiment, the first flexible printed circuit board 400 includes a plurality of source voltage supplying lines (not shown) applying the source voltage Vdd that is from the data printed circuit board 220 to the display panel 100. Alternatively, the first flexible printed circuit board 400 may include only one source voltage supplying line. When the first flexible printed circuit board 400 has only one source voltage supplying line, a width of the signal source voltage supplying line within the first flexible printed circuit board 400 is wider than a width of each of the other source voltage supplying lines provided within the OLED, such as the source voltage supplying lines 240. Alternatively, the width of the source voltage supplying line within the first flexible printed circuit board 400 may be substantially equal to a sum of the widths of each of the source voltage supplying lines.

An amount of current formed by the source voltage Vdd applied to the display panel 100 through both the first flexible printed circuit board 400 and the data TCPs 230 is greater than that of the source voltage Vdd applied to the display panel 100 through the data TCPs 230 alone. In an exemplary embodiment, the source voltage Vdd from the data TCPs 230 and the first flexible printed circuit board 400 is applied to the source electrode 133 of the second TFT 130 in the display panel 100 shown in FIG. 2.

The gate driving part 300 includes a plurality of gate driving chips 310 and a gate printed circuit board 320. The gate printed circuit board 320 is electrically connected to the display panel 100 through a plurality of gate TCPs 330. Each gate driving chip 310 may be positioned on a gate TCP 330.

The gate TCPs 330 are spaced apart from each other along the second peripheral region PA2 of the display panel 100. A first end portion of each gate TCP 330 is attached to the second peripheral region PA2. A second end portion of each gate TCP 330 is attached to the gate printed circuit board 320. The first and second end portions of the gate TCPs 330 are attached to the display panel 100 and the data printed circuit board 320, respectively, through ACFs. In an exemplary embodiment, the gate driving chips 310 are on the gate TCPs 330, respectively.

Each of the gate TCPs 330 includes a common voltage supplying line 340 to apply the common voltage Vcom from the gate printed circuit board 320 to the display panel 100 through an ACF.

The second flexible printed circuit board 500 is disposed between adjacent gate TCPs 330. That is, a first portion of the second flexible printed circuit board 500 is attached to the second peripheral region PA2 disposed between adjacent gate TCPs 330, and a second portion of the second flexible printed circuit board 500 is attached to the gate printed circuit board 320. The first and second end portions of the second flexible printed circuit board 500 are attached to the display panel 100 and the gate printed circuit board 320, respectively, through ACFs. While an alternating pattern of gate TCP 330, second flexible printed circuit board 500, gate TCP 330, second flexible printed circuit board 500, and so on, is demonstrated, it should be understood that alternate patterns for placing the second flexible printed circuit boards 500 in relation to the gate TCPs 330 are also within the scope of these embodiments.

In an exemplary embodiment, the second flexible printed circuit board 500 includes a plurality of source voltage supplying lines (not shown) applying the common voltage Vcom from the gate printed circuit board 320 to the display panel 100. The second flexible printed circuit board 500 may instead include only one common voltage supplying line. When the second flexible printed circuit board 500 has only one common voltage supplying line, a width of the common voltage supplying line within the second flexible printed circuit board 500 is wider than a width of each of the common voltage supplying lines provided within the OLED, such as the common voltage supplying lines 340. Alternatively, the width of the common voltage supplying line within the second flexible printed circuit board 500 may be substantially equal to a sum of the widths of each of the common voltage supplying lines 340.

An amount of current formed by the common voltage Vcom applied to the display panel 100 through both the second flexible printed circuit board 500 and the gate TCPs 330 is greater than that of the common voltage Vcom applied to the display panel through the gate TCPs 330 alone. The common voltage Vcom is applied to the cathode electrode 124 of the organic EL diode 120 shown in FIG. 2.

Each of the first and second flexible printed circuit boards 400 and 500 has various properties such as higher conductivity, wider current path, etc. than the TCPs 230, 330, thereby applying more currents than the TCPs 230, 330 alone. That is, when the first and second flexible printed circuit boards 400 and 500 are used in conjunction with the TCPs 230, 330, more current is applied to the display panel 100.

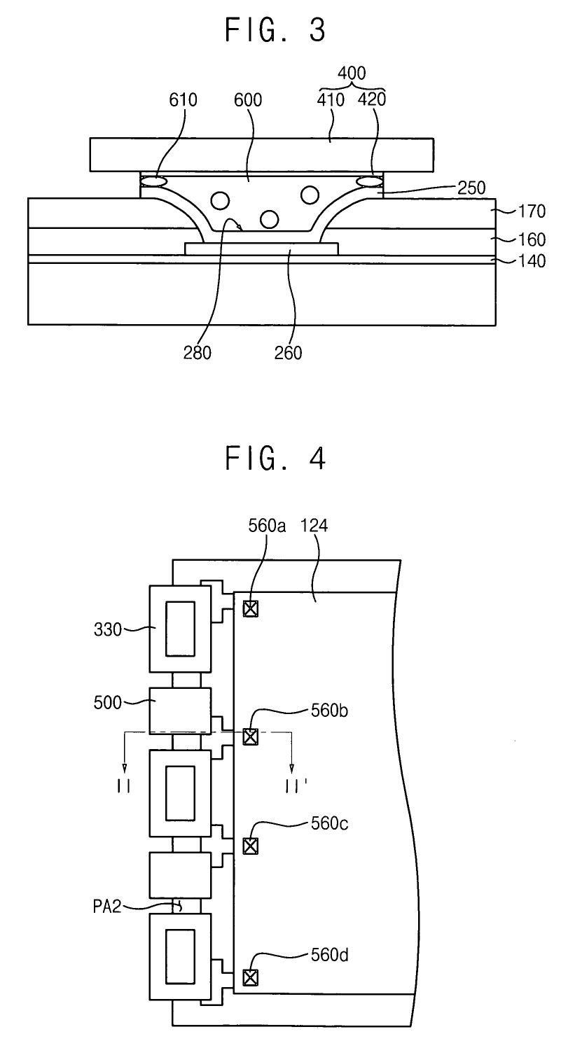

FIG. 3 is a cross-sectional view taken along line I-I′ of FIG. 1.

Referring to FIG. 3, a source voltage electrode pad 260 is on the first peripheral region PA1 of the display panel 100 and may be positioned in areas corresponding to the locations of the first flexible printed circuit boards 400, and may also be positioned to electrically connect to the source voltage supplying line 240 provided on the data TCPs 230. Thus, while only one source voltage electrode pad 260 is illustrated, there may be a plurality of source voltage electrode pads 260 within the peripheral region PA1. A pad passivation layer 250 is on the source voltage electrode pad 260. The pad passivation layer 250 is electrically connected to the source voltage electrode pad 260 through a first contact hole 280 that is formed by eliminating a portion of the first insulating interlayer 160 and a portion of the second insulating interlayer 170 that are on the source voltage electrode pad 260.

The source voltage electrode pad 260 is electrically connected to the source voltage line within the display panel 100 of FIG. 1, and includes a material substantially identical to that of the source voltage line. The source voltage electrode pad 260 may be formed from a same layer as the source voltage line. Also, the source voltage line includes a material substantially identical to that of the second source electrode 133 of the second TFT 130. The source voltage line may be formed from a same layer as the second source electrode 133. Thus, the source voltage electrode pad 260 includes a material, such as a metal, substantially identical to the second source electrode 133 of the second TFT 130. The source voltage electrode pad 260 may be formed from a same layer as the second source electrode 133. Alternatively, the source voltage electrode pad 260 may include a material, such as a metal, substantially identical to the second gate electrode 131 or the second drain electrode 134 of the second TFT 130. The source voltage electrode pad 260 may be formed from a same layer as the second gate electrode 131 and/or the second drain electrode 134.

The pad passivation layer 250 includes ITO or IZO that is substantially identical to a material used for the anode electrode 122 of the organic EL diode 120. The pad passivation layer 250 may be formed from a same layer as the anode electrode 122.

The insulating layer 140 may be termed a gate insulating layer, since it overlies and insulates the first and second gate electrodes 111, 131.

The first flexible printed circuit board 400 includes a first base film 410 and at least one source voltage supplying line 420. In an exemplary embodiment, the first flexible printed circuit board 400 is electrically connected to the source voltage electrode pad 260 through an ACF 600. The ACF 600 has a plurality of conductive balls 610 for providing the electrical connection between the source voltage electrode pad 260 and the at least one source voltage supplying line 420.

That is, the source voltage supplying line 420 is electrically connected to the source voltage electrode pad 260 through the pad passivation layer 250 and the conductive balls 610 of the ACF 600.

Thus, the source voltage Vdd from the data printed circuit board 220 is applied to the pad passivation layer 250 through the source voltage supplying line 420 of the first flexible printed circuit board 400. The source voltage Vdd that is applied to the pad passivation layer 250 is applied to the electrode pad 260. The source voltage that is applied to the electrode pad 260 is applied to the second source electrode 133 of the second TFT 130 through the source voltage line. Source voltage Vdd may also be similarly applied through the source voltage supplying line 240.

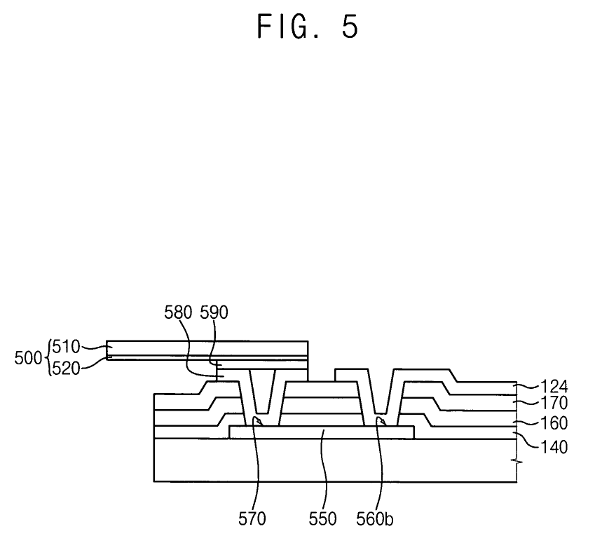

FIG. 4 is a plan view showing an exemplary second peripheral region PA2 of the display panel 100 of FIG. 1. FIG. 5 is a cross-sectional view taken along line II-II′ of FIG. 4.

Referring FIGS. 4 and 5, a plurality of common electrode pads 550 are disposed on the second peripheral region PA2 of the display panel 100. The common electrode pads 550 are electrically connected to the cathode electrode 124 through a second contact hole 560a, a third contact hole 560b, a fourth contact hole 560c, and a fifth contact hole 560d, where the second, third, fourth, and fifth contact holes 560a-560d are positioned adjacent first sides of the common electrode pads 550.

The common electrode pads 550 include a material substantially identical to that of the gate electrodes 111, 131 of the first and second TFTs 110 and 130, respectively. The common electrode pads 550 may additionally be formed from a same layer as the gate electrodes 111, 131 of the first and second TFTs 110 and 130, respectively.

The second contact hole 560a, the third contact hole 560b, the fourth contact hole 560c, and the fifth contact hole 560d are formed by removing a portion of the first insulating interlayer 160 and a portion of the second insulating interlayer 170 corresponding to first end portions of the common electrode pads 550. The first end portions of the common electrode pads 550 are exposed through the second contact hole 560a, the third contact hole 560b, the fourth contact hole 560c and the fifth contact hole 560d. The cathode electrode 124 is thus formed on the first end portions of the common electrode pad 550 through the contact holes 560a, 560b, 560c, and 560d.

A sixth contact hole 570 is formed within each common electrode pad 550 by removing a portion of the first insulating interlayer 160 and a portion of the second insulating interlayer 170 corresponding to second end portions of the common electrode pads 550. The second end portions of the common electrode pads 550 may be positioned below the second flexible printed circuit boards 500 and the gate TCPs 330. That is, sides of the second flexible printed circuit boards 500 and the gate TCPs 330 overlap the second end portions of the common electrode pads 550. The second end portions of the common electrode pads 550 are exposed through the sixth contact holes 570. In an exemplary embodiment, a common electrode pad passivation layer 580 is formed on the second end portions of the common electrode pads 550 by overlying the sixth contact holes 570. The common electrode pad passivation layer 580 includes ITO or IZO that is substantially identical to that of the anode electrode 122 of the organic EL diode 120 of FIG. 2. In addition, the common electrode pad passivation layer 580 may be formed from a same layer as the anode electrode 122.

The second flexible printed circuit board 500 includes a second base film 510 and at least one common voltage supplying line 520. Each of the second flexible printed circuit boards 500 is electrically connected to a second end portion of one of the common electrode pads 550 through an ACF 590.

That is, each second flexible printed circuit board 500 is electrically connected to a second end portion of one of the common electrode pads 550 through the common voltage supplying line 520, the common electrode pad passivation layer 580, and the ACF 590.

Thus, the common voltage Vcom from the gate printed circuit board 320 is applied to the second end portions of the common electrode pads 550 through the second flexible printed circuit board 500. The common voltage Vcom that is applied to the common electrode pads 550 is applied to the cathode electrode 124 that is electrically connected to the first end portions of the common electrode pads 550 through the contact holes 560. Additionally, the common voltage Vcom from the gate printed circuit board 320 may be similarly passed to the display panel 100 through the common voltage supplying lines 340 provided on the gate TCPs 330.

In an exemplary embodiment, a plurality of sixth contact holes 570 and a plurality of common electrode pad passivation layers 580 are formed between the common voltage supplying lines 340 of the gate TCPs 330 and the common electrode pads 550 so that the common voltage supplying lines 340 of the gate TCPs 330 are electrically connected to the common electrode pads 550 in a manner similar to the electrical connection of the second flexible printed circuit boards 500 to the common electrode pads 550.

As described above, the OLED includes at least one of the first flexible printed circuit boards 400 so that an amount of current formed by the source voltage Vdd that is applied to the display panel 100 is increased, as compared to an OLED that does not have at least one of the first flexible printed circuit boards 400.

Also, the OLED includes at least one of the second flexible printed circuit boards 500 so that an amount of current formed by the common voltage Vcom that is applied to the display panel 100 is increased, as compared to an OLED that does not have at least one of the second flexible printed circuit boards 500.

Further, the common electrode pads 550 may include material, such as a metal, substantially identical to that of the drain electrodes 114, 134 or source electrodes 113, 133 of the first or second TFTs 110 or 130, respectively. Additionally, the common electrode pads 550 may be formed from a same layer as the drain electrodes 114, 134 and/or source electrodes 113, 133.

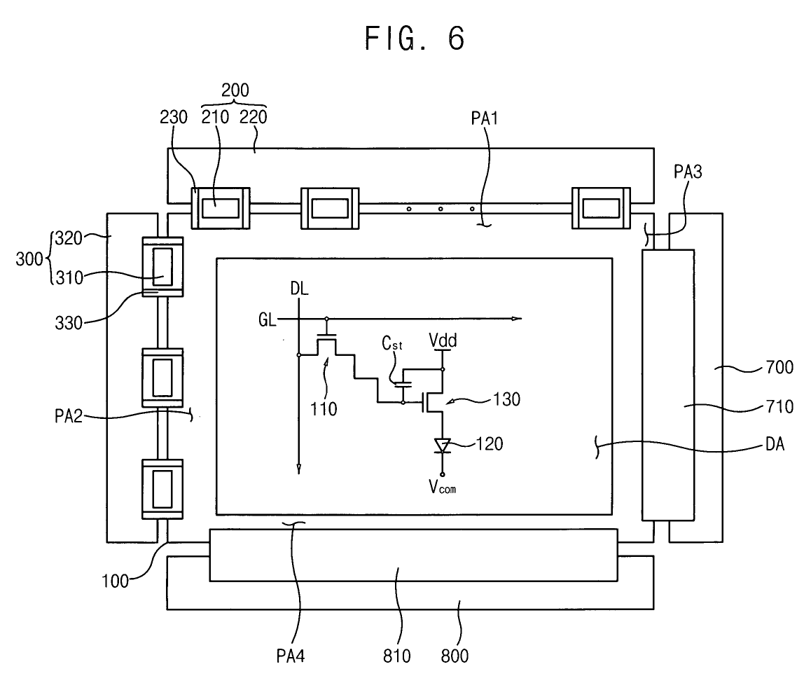

FIG. 6 is a plan view of another exemplary embodiment of an OLED.

Referring to FIG. 6, the OLED includes a display panel 100, a data driving part 200, a gate driving part 300, a first voltage supplying printed circuit board 700, and a second voltage supplying printed circuit board 800.

The display panel 100 includes a display region DA, a first peripheral region PA1 adjacent to a first side of the display region DA, a second peripheral region PA2 adjacent to a second side of the display region DA and adjacent to a side of the first peripheral region PA1, a third peripheral region PA3 adjacent to a third side of the display region DA and adjacent to another side of the first peripheral region PA1, and a fourth peripheral region PA4 adjacent to a fourth side of the display region DA. The first and fourth sides of the display region DA may be substantially parallel to each other, and the second and third sides of the display region DA may be substantially parallel to each other. The fourth peripheral region PA4 is between the second and third peripheral regions PA2 and PA3. The third peripheral region PA3 is substantially parallel to the second peripheral region PA2. Likewise, the fourth peripheral region PA4 is substantially parallel to the first peripheral region PA1.

The display panel 100, the data driving part 200, and the gate driving part 300 are the same as in the previous embodiment. Thus, the same reference numerals will be used to refer to the same or like parts as those described in the previous embodiment and any further explanation will be omitted.

The first voltage supplying printed circuit board 700 is arranged adjacent to the third peripheral region PA3 and the third side of the display region DA, and may be spaced from the third peripheral region PA3. The first voltage supplying printed circuit board 700 may extend longitudinally in a direction substantially parallel to and spaced from the third side of the display region DA. The first voltage supplying printed circuit board 700 applies a source voltage Vdd to the display panel 100 through the third peripheral region PA3. The first voltage supplying printed circuit board 700 is electrically connected to the display panel 100 through a first flexible printed circuit board 710 extending longitudinally in a direction substantially parallel to and spaced from the third side of the display region DA.

A first end portion of the first flexible printed circuit board 710 is attached to the third peripheral region PA3, and a second end portion of the first flexible printed circuit board 710 is attached to the first voltage supplying printed circuit board 700. Thus, the first flexible printed circuit board 710 applies the source voltage Vdd from the first voltage supplying printed circuit board 700 to the display panel 100.

Also, the first flexible printed circuit board 710 makes contact with the third peripheral region PA3. A contacting length between the first flexible printed circuit board 710 and the third peripheral region PA3 may be substantially the same as a length of the third side of the display region DA arranged adjacent to the third peripheral region PA3.

In an exemplary embodiment, the first flexible printed circuit board 710 may include a plurality of source voltage supplying lines or may instead include only one source voltage supplying line. When the first flexible printed circuit board 710 has only one source voltage supplying line, a width of the source voltage supplying line is wider than a width of each of the other source voltage supplying lines within the OLED, such as the source voltage supplying lines 240 provided in the data TCPs 230. Alternatively, the width of the source voltage supplying line provided in the first flexible printed circuit board 710 may be substantially equal to a sum of the widths of the source voltage supplying lines provided in the data TCPs 230. Thus, an amount of current formed by the source voltage Vdd applied to the display panel 100 through both the first flexible printed circuit board 710 and the data TCPs 230 is greater than that of the source voltage Vdd applied to the display panel 100 through the data TCPs 230 alone.

The second voltage supplying printed circuit board 800 is arranged adjacent to the fourth peripheral region PA4 and the fourth side of the display region DA, and may be spaced from the fourth peripheral region PA4. The second voltage supplying printed circuit board 800 may extend longitudinally in a direction substantially parallel to and spaced from the fourth side of the display region DA. The second voltage supplying printed circuit board 800 applies a common voltage Vcom to the display panel 100 through the fourth peripheral region PA4. The second voltage supplying printed circuit board 800 is electrically connected to the display panel 100 through a second flexible printed circuit board 810 extending longitudinally in a direction substantially parallel to and spaced from the fourth side of the display region DA.

A first end portion of the second flexible printed circuit board 810 is attached to the fourth peripheral region PA4, and a second end portion of the second flexible printed circuit board 810 is attached to the second voltage supplying printed circuit board 800. Thus, the second flexible printed circuit board 810 applies the common voltage Vcom from the second voltage supplying printed circuit board 800 to the display panel 100.

The second flexible printed circuit board 810 also makes contact with the fourth peripheral region PA4. A contacting length between the second flexible printed circuit board 810 and the fourth peripheral region PA4 may be substantially the same as a length of the fourth side of the display region DA arranged adjacent to the fourth peripheral region PA4.

In an exemplary embodiment, the second flexible printed circuit board 810 may include a plurality of common voltage supplying lines or may instead include only one common voltage supplying line. When the second flexible printed circuit board 810 has only one common voltage supplying line, a width of the common voltage supplying line within the second flexible printed circuit board 810 is wider than a width of each of the other common voltage supplying lines within the OLED, such as the common voltage supplying lines 340 within the gate TCPs 330. Alternatively, the width of the common voltage supplying line within the second flexible printed circuit board 810 may be substantially equal to a sum of the widths of the common voltage supplying lines within the gate TCPs 330. Thus, an amount of current formed by the common voltage Vcom applied to the display panel 100 through both the second flexible printed circuit board 810 and the gate TCPs 330 is greater than that of the source voltage Vcom applied to the display panel 100 through the gate TCPs 330 alone.

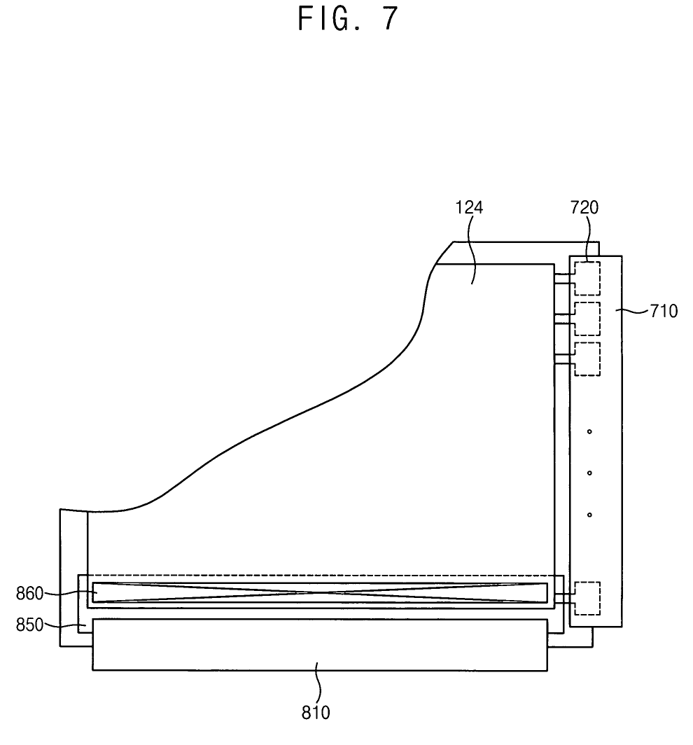

FIG. 7 is a plan view showing an exemplary third peripheral region PA3 and an exemplary fourth peripheral region PA4 of the display panel 100 of FIG. 6.

Referring to FIG. 7, a plurality of source voltage electrode pads 720 are on the third peripheral region PA3 of the display panel 100 so that the source voltage Vdd from the first flexible printed circuit board 710 is applied to the second source electrode 133 of the second TFT 130 of FIG. 2. In an exemplary embodiment, the source voltage electrode pad 720 is electrically connected to the source voltage line so that the source voltage Vdd is applied to the second source electrode 133 of the second TFT 130 through the source voltage line.

Further, a plurality of anode electrodes 122 (FIG. 2) of organic EL diodes 120 are electrically connected to one another through source voltage lines and a line, such as a metal line, that electrically connects the source voltage lines to one another. Therefore, the source voltage Vdd from the source voltage electrode pad 720 is applied to the source electrode 133 (FIG. 2) of the second TFT 130.

The first flexible printed circuit board 710 is electrically connected to the source voltage electrode pads 720 through an ACF. That is, the ACF having a plurality of conductive balls, provided in a resin of the ACF, is disposed under the first flexible printed circuit board 710 so that the first flexible printed circuit board 710 is electrically connected to the source voltage electrode pads 720 through the conductive balls.

Thus, the source voltage Vdd from the first voltage supplying printed circuit board 700 is applied to the second source electrode 133 of the second TFT 130 through the source voltage electrode pads 720.

A common voltage electrode pad 850 is on the fourth peripheral region PA4 of the display panel 100 so that the common voltage Vcom is applied to the cathode electrode 124 of the organic EL diode 120. In an exemplary embodiment, the common voltage electrode pad 850 is electrically connected to the cathode electrode 124 through a contact hole 860.

A length of the contact hole 860 is substantially the same as a side length of the cathode electrode 124 arranged adjacent the fourth peripheral region PA4. That is, a contact area between the cathode electrode 124 and the common voltage electrode pad 850 may be increased due to the increased length of the contact hole 860. Thus, when the contact area of the cathode electrode 124 and the common voltage electrode pad 850 increases, contact resistance between the cathode electrode 124 and the common voltage electrode pad 850 decreases, so that an amount of current formed by common voltage applied to the display panel 100 is increased.

In an exemplary embodiment, the first flexible printed circuit board 710 applies the source voltage Vdd to the display panel 100. Alternatively, the common voltage Vcom may be applied to the display panel 100 through the first flexible printed circuit board 710.

The second flexible printed circuit board 810 applies the common voltage Vcom to the display panel 100. Alternatively, the source voltage Vdd may be applied to the display panel 100 through the second flexible printed circuit board 810.

In an exemplary embodiment, the contact area between the cathode electrode 124 and the common voltage electrode pad 850 increases due to the contact hole 860 extending substantially the same length as a length of the cathode electrode 124 along the fourth side of the display region DA. Alternatively, or additionally, a contact area between the source voltage electrode pad 720 and the first flexible printed circuit board 710 may increase by increasing a size of a contact hole positioned for contacting the source voltage electrode pad 720 to the first flexible printed circuit board 710.

The OLED may further include one or more flexible printed circuit boards, such as the first and second flexible printed circuit boards 400, 500, disposed between the data TCPs 230 and/or between the gate TCPs 330, so that an amount of current formed by the source voltage Vdd or the common voltage Vcom that is applied to the display panel 100 may increase.

In an exemplary embodiment, the source voltage Vdd and the common voltage Vcom are applied to the display panel 100 through the first and second flexible printed circuit boards 710 and 810, respectively. Alternatively, the source voltage Vdd and the common voltage Vcom may be applied to the display panel 100 through just the first flexible printed circuit 710. Instead, or in addition, the source voltage Vdd and the common voltage Vcom may be applied to the display panel 100 through the second flexible printed circuit board 810.

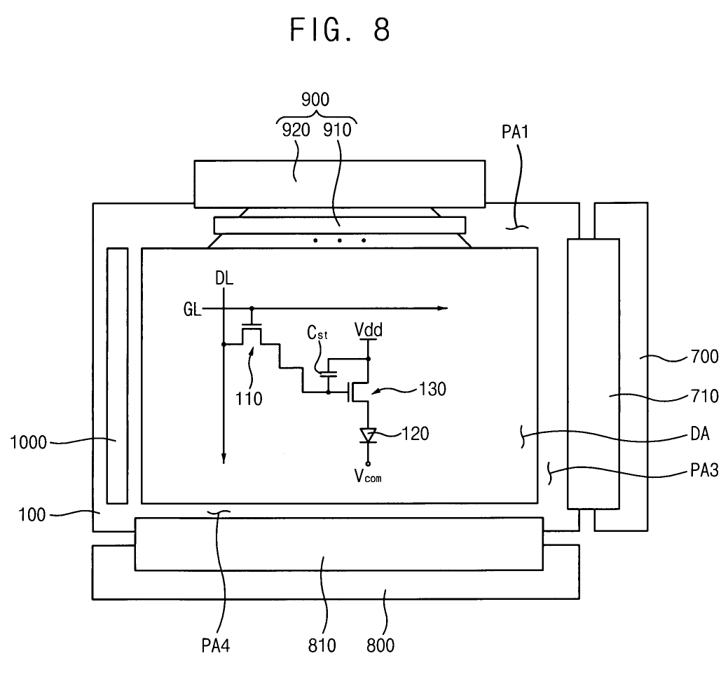

FIG. 8 is a plan view of another exemplary embodiment of an OLED.

Referring to FIG. 8, the OLED includes a display panel 100, a data driving part 900, a gate driving part 1000, a first voltage supplying printed circuit board 700, and a second voltage supplying printed circuit board 800.

As previously described, the first voltage supplying printed circuit board 700 is electrically connected to the display panel 100 through a first flexible printed circuit board 710. The second voltage supplying printed circuit board 800 is electrically connected to the display panel 100 through a second flexible printed circuit board 810.

The first and second voltage supplying printed circuit boards 700 and 800 and the first and second flexible printed circuit boards 710 and 810 of FIG. 8 are the same as in FIGS. 6 and 7. Thus, the same reference numerals will be used to refer to the same or like parts as those described in FIGS. 6 and 7, and any further explanation concerning the above elements will be omitted.

The display panel 100 includes a display region DA, a first peripheral region PA1, a second peripheral region PA2, a third peripheral region PA3, and a fourth peripheral region PA4.

A plurality of data lines DL and a plurality of gate lines GL are formed in the display region DA of the display panel 100, where only one exemplary data line DL and one exemplary gate line GL are illustrated for clarity. The gate lines GL cross the data lines DL by extending in a substantially perpendicular direction to the gate lines GL. The gate lines GL may be insulated from the data lines DL by an insulating layer provided there between. A pixel region is defined in a matrix shape on a region defined by a pair of adjacent data lines DL and a pair of adjacent gate lines GL.

An organic light emitting element is in the pixel region. The organic light emitting element includes a first TFT 110, a storage capacitor Cst, an organic EL diode 120, and a second TFT 130. The organic light emitting element of FIG. 8 is the same as in the prior embodiments. Thus, the same reference numerals will be used to refer to the same or like parts as those previously described and illustrated, and any further explanation concerning the above elements will be omitted.

The data driving part 900 includes a data driving chip 910 and a data printed circuit board 920. The data driving chip 910 is mounted on the first peripheral region PA1 as a chip shape. An end portion of the data printed circuit board 920 is attached to an end portion of the display panel 100 adjacent to the first peripheral region PA1 through an ACF. The data driving chip 910 is electrically connected to the data lines DL in the display region DA. The data driving chip 910 receives an image signal from the data printed circuit board 920 to apply a first driving signal to the data lines DL based on the image signal.

The gate driving part 1000 is formed from the same layers as the first and second TFTs 110 and 130 of the display panel 100. The gate driving part 1000 is on the second peripheral region PA2, and may be formed completely within the second peripheral region PA2. The gate driving part 1000 is electrically connected to the gate lines GL in the display region DA. In this exemplary embodiment, the gate driving part 1000 applies a second driving signal to the gate lines GL.

In an exemplary embodiment, the data driving chip 910 is the chip. Alternatively, a data driving part (not shown) that applies the second driving signal to the gate lines GL may be formed from the same layers as the first and second TFTs 110 and 130 of the display panel 100. Such a data driving part may be on the first peripheral region PA1, and arranged in a similar manner as the gate driving part 1000.

According to an exemplary embodiment, a source voltage Vdd is applied to the display panel 100 through the first flexible printed circuit board 710 so that an amount of the source voltage Vdd that is applied to the display panel 100 is increased. A common voltage Vcom is applied to the display panel 100 through the second flexible printed circuit board 810 so that an amount of the common voltage Vcom that is applied to the display panel 100 is increased.

According to the present invention, the flexible printed circuit boards may be disposed between the data TCPs or the gate TCPs. Alternatively, the flexible printed circuit board may be attached to a peripheral region of the display panel without the data TCPs or the gate TCPs. The data and gate TCPs serve as signal transmission members that are configured to electrically connect the circuit boards to the display panel to transmit driving signals and voltages to the display panel. The flexible printed circuit boards serve as voltage transmission members configured to transmit voltage to the display panel.

Thus, the source voltage Vdd or the common voltage Vcom is applied to the display panel through the TCPs and the flexible printed circuit boards so that the amount of a current that is applied to the organic light emitting element increases.

The contact hole between the electrode pad associated with the flexible printed circuit board and the cathode electrode of the organic electrode luminescent element may be increased in size. That is, the contact area between the electrode pad associated with the flexible printed circuit board and the cathode electrode of the organic electrode luminescent element increases in size so that the amount of the driving current that is applied to the organic electrode luminescent element may increase.

Although the exemplary embodiments of the present invention have been described, it is understood that the present invention should not be limited to these exemplary embodiments but various changes and modifications may be made by one ordinary skilled in the art within the spirit and scope of the present invention as hereinafter claimed. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. An organic light emitting display device comprising:
a display panel having a display region and a plurality of peripheral regions, the display panel configured to display an image by an organic light emitting element within the display region;
a first printed circuit board arranged adjacent one of the peripheral regions, the first printed circuit board applying a first driving signal and a voltage to the display panel;
a plurality of first signal transmission members electrically connecting the first printed circuit board to the display panel to transmit the first driving signal and the voltage to the display panel; and
a first voltage transmission member transmitting the voltage to the display panel.

2. The organic light emitting display device of claim 1, wherein the voltage applied to the display panel comprises a source voltage or a common voltage.

3. The organic light emitting display device of claim 1, wherein the first signal transmission members are films that transmit gate signals, and wherein the voltage applied to the display panel is a common voltage.

4. The organic light emitting display device of claim 1, wherein the first signal transmission members are films that transmit data signals, and the voltage applied to the display panel is a source voltage.

5. The organic light emitting display device of claim 1, comprising a voltage supplying line in each of the first signal transmission members, the voltage supplying line applying the voltage to the display panel.

6. The organic light emitting display device of claim 1, wherein the plurality of peripheral regions comprise a first peripheral region to which the first printed circuit board is arranged adjacent, a second peripheral region, a third peripheral region, and a fourth peripheral region, and a first end portion of each first signal transmission member is on the first printed circuit board and a second end portion of each first signal transmission member is on the first peripheral region, and the first voltage transmission member is positioned between an adjacent pair of first signal transmission members.

7. The organic light emitting display device of claim 6, further comprising:
a second printed circuit board arranged adjacent the second peripheral region, the second printed circuit board applying a second driving signal to the display panel;
a plurality of second signal transmission members spaced apart from one another by a first distance, the second signal transmission members electrically connecting the second printed circuit board to the display panel; and
a second voltage transmission member applying voltage to the display panel.

8. The organic light emitting display device of claim 7, having an arrangement including the second voltage transmission member disposed between an adjacent pair of second signal transmission members.

9. The organic light emitting display device of claim 7, wherein the organic light emitting element comprises:
a switching element;
a current control element;
a storage capacitor connected between the switching element and the current control element; and
an organic light emitting diode having an anode electrode electrically connected to the current control element, a cathode electrode receiving the voltage, and an organic light emitting layer interposed between the anode electrode and the cathode electrode,
wherein the cathode electrode makes contact with the second voltage transmission member, and a contacting length between the cathode electrode and the second voltage transmission member is substantially same as a side length of the display region adjacent to the third peripheral region or the fourth peripheral region.

10. The organic light emitting display device of claim 9, wherein the first printed circuit board comprises a material substantially the same as material used for the switching element.

11. The organic light emitting display device of claim 1, wherein the first voltage transmission member is a flexible printed circuit board.

12. The organic light emitting display device of claim 1, wherein the first voltage transmission member does not transmit a driving signal to the display panel.

13. An organic light emitting display device comprising:
a display panel having a display region, a first peripheral region, a second peripheral region, a third peripheral region, and a fourth peripheral region, the first to fourth peripheral regions adjacent the display region, the display panel displaying an image by an organic light emitting element within the display region;
a first printed circuit board arranged adjacent one of the first, second, third and fourth peripheral regions, the first printed circuit board applying a first driving signal to the display panel; and
a first voltage transmission member on another of the first, second, third and fourth peripheral regions, the first voltage transmission member applying a voltage to the display panel.

14. The organic light emitting display device of claim 13, wherein the voltage applied to the display panel is a source voltage.

15. The organic light emitting display device of claim 14, further comprising a second printed circuit board arranged adjacent the first voltage transmission member, the second printed circuit board applying the source voltage to the first voltage transmission member.

16. The organic light emitting display device of claim 13, wherein the voltage applied to the display panel is a common voltage.

17. The organic light emitting display device of claim 16, further comprising a second printed circuit board arranged adjacent the first voltage transmission member, the second printed circuit board applying the common voltage to the first voltage transmission member.

18. The organic light emitting display device of claim 13, wherein the first voltage transmission member is a flexible printed circuit board.

19. The organic light emitting display device of claim 13, wherein the first printed circuit board is adjacent the first peripheral region, and the first voltage transmission member is adjacent the third peripheral region or the fourth peripheral region.

20. The organic light emitting display device of claim 19, wherein the organic light emitting element comprises:
a switching element;
a current control element;
a storage capacitor connected between the switching element and the current control element; and
an organic light emitting diode having an anode electrode electrically connecting to the current control element, a cathode electrode receiving the common voltage from the first voltage transmission member, and an organic light emitting layer interposed between the anode electrode and the cathode electrode,
wherein the cathode electrode makes contact with the first voltage transmission member, and a contacting length between the cathode electrode and the first voltage transmission member is substantially the same as a side length of the display region adjacent the third peripheral region or the fourth peripheral region.

21. The organic light emitting display device of claim 20, wherein the first printed circuit board comprises a material substantially to the same as a material used for the current control element.

22. The organic light emitting display device of claim 19, further comprising:
a second printed circuit board arranged adjacent the second peripheral region, the second printed circuit board applying a second driving signal to the display panel;
a plurality of first signal transmission members spaced apart from one another by a first distance, the first signal transmission members electrically connecting the first printed circuit board to the display panel;
a plurality of second signal transmission members spaced apart from one another by a second distance, the second signal transmission members electrically connecting the second printed circuit board to the display panel; and
a second voltage transmission member disposed between the two adjacent first signal transmission members or between two adjacent second signal transmission members, the second voltage transmission member applying the voltage to the display panel.

23. The organic light emitting display device of claim 22, wherein at least one of the first signal transmission members and the second signal transmission members comprise a voltage supplying line applying the voltage to the display panel.

24. The organic light emitting display device of claim 13, wherein the first voltage transmission member does not transmit a driving signal to the display panel.

25. An organic light emitting display device comprising:
a display panel having a display region, a first peripheral region, a second peripheral region, a third peripheral region, and a fourth peripheral region, the first to fourth peripheral regions adjacent the display region, the display panel displaying an image by an organic light emitting element;
a first printed circuit board adjacent the first peripheral region, the first printed circuit board applying a first driving signal and a first voltage to the display panel;
a second printed circuit board adjacent the second peripheral region, the second printed circuit board applying a second driving signal and a second voltage to the display panel;
a plurality of first signal transmission members spaced apart from one another by a first distance, the first signal transmission members electrically connecting the first printed circuit board to the display panel;
a plurality of second signal transmission members spaced apart from one another by a second distance, the second signal transmission members electrically connecting the second printed circuit board to the display panel;
a first voltage transmission member disposed between the first signal transmission members, the first voltage transmission member applying the first voltage to the display panel; and
a second voltage transmission member disposed between the second signal transmission members, the second voltage transmission member applying the second voltage to the display panel.

26. The organic light emitting display device of claim 25, further comprising:
a third voltage transmission member disposed on the third peripheral region, the third voltage transmission member applying the first voltage to the display panel; and
a fourth voltage transmission member disposed on the fourth peripheral region, the fourth voltage transmission member applying the second voltage to the display panel.

27. The organic light emitting display device of claim 25, wherein the first and second voltage transmission members do not transmit the first and second driving signals to the display panel.

28. An organic light emitting display device comprising:
a display panel;
a signal transmission member transmitting a driving signal to the display panel; and,
a voltage transmission member separate from the signal transmission member and transmitting only a voltage to the display panel.

29. The organic light emitting display device of claim 28, wherein the driving signal is one of a gate signal and a data signal, and the voltage is one of a common voltage and a source voltage.

30. The organic light emitting display device of claim 28, further comprising a display region within the display panel, and a first peripheral region, a second peripheral region, a third peripheral region, and a fourth peripheral region of the display panel surrounding the display region, the signal transmission member electrically connected to on one of the peripheral regions, and the voltage transmission member electrically connected to another of the peripheral regions.

31. The organic light emitting display of claim 30, wherein the voltage transmission member has a substantially same length as a length of the display region.

32. The organic light emitting display device of claim 28, further comprising a display region within the display panel, and a first peripheral region, a second peripheral region, a third peripheral region, and a fourth peripheral region of the display panel surrounding the display region, the signal transmission member electrically connected to the first peripheral region, and the voltage transmission member electrically connected to the first peripheral region.
